(19) United States
(12) Patent Application Publication
(10) Pub. No.: US 2002/0159258 A1
(43) Pub. Date: Oct. 31, 2002

(54) Rainbow glow night light

(76) Inventor: Jeffrey Walter Beeman, El Sobrante, CA (US)

Correspondence Address: HOWARD COHEN, 1105 THE ALAMEDA, BERKELEY, CA, 94707, US

(21) Appl. No.: 09/944,235

(22) Filed: Sep. 4, 2001

Related U.S. Application Data
(60) Provisional application No. 60/286,612, filed on Apr. 27, 2001.

(51) Int. Cl. F21S 8/00; F21V 9/00

(52) U.S. Cl. 362/231; 362/235; 362/249; 362/147

(57) ABSTRACT

A nightlight includes a housing configured similarly to a typical electrical plug connector, and a pair of spade lug connectors to be plug-engaged in a typical electrical power receptacle. Within the housing, an electrical circuit is supported that includes a pick-off capacitor connected to a full wave bridge rectifier. A plurality of LEDs of differing colors are mounted on an outer surface of the housing and are powered by the rectifier. The LEDs are aimed to direct their illumination toward the wall in which the electrical power receptacle is mounted, each LED creating a pool of light of its respective color on the wall. The LEDs may be aimed so that their circles of illumination overlap to some extent, whereby the colors may blend and form a rainbow display of spectral colors that blend together in varying degrees to approximate the color variety and display of a rainbow.

### REFERENCE TO RELATED APPLICATION

This application claims priority based on Provisional Patent Application Serial No. 60/286,612, filed Apr. 27, 2001.

### BACKGROUND OF THE INVENTION

The present invention relates to night lights and, more particularly, to night lights that employ LED light source(s).

Night lights are known in the prior art as low power lighting devices that are designed to alleviate the gloom of night without interrupting sleep. Although many forms of night lights are commercially available, they typically include a lamp fixture for a low wattage lamp, and electrical spade lugs adapted to be plugged into a power receptacle. The low power lamp, generally consuming about 10 watts, casts a pool of light in the immediate area of the night light. For those who harbor fears caused by total darkness, such as young children, the illumination of a night light is a comfort that eases anxieties. Night lights also enable individuals who awaken and arise nocturnally to avoid obstacles without resorting to turning on room lights that may awaken other sleepers.

It is desirable to provide a night light that consumes the least amount of power, particularly considering that a night light is typically operating on a continual basis for 10 hours or more each night. In addition, it is desirable to provide a night light that provides a visual display that is more attractive than the typical incandescent illumination known in the prior art.

### SUMMARY OF THE PRESENT INVENTION

The present invention generally comprises a night light employing LEDs as a light source. The LEDs consume minimal power while providing a colored rainbow light pattern that is visually arresting and interesting.

The nightlight includes a housing configured similarly to a typical electrical plug connector, and includes a pair of spade lug connectors extending therefrom and adapted to be plug-engaged in a typical electrical power receptacle known in the prior art. Within the housing, an electrical circuit is supported that includes a pick-off capacitor connected to a full wave bridge rectifier. A plurality of LEDs of differing colors are mounted on an outer surface of the housing and are powered by the rectifier. The LEDs are aimed to direct their illumination toward the wall in which the electrical power receptacle is mounted, each LED creating a pool of light of its respective color on the wall. The LEDs may be aimed so that their circles of illumination overlap to some extent, whereby the colors may blend and form a rainbow display of spectral colors that blend together in varying degrees to approximate the color variety and display of a rainbow.

The nightlight may be actuated merely by plugging it into any convenient power receptacle, and switched off by unplugging from the receptacle. Thus, it is noted that there is no switch required for the nightlight, and, indeed, no moving parts whatsoever. The nightlight combines extremely long-lived LED light sources with a power circuit that avoids any failure mode associated with moving parts, thus bolstering the longevity of the device.

### BRIEF DESCRIPTION OF THE DRAWING

FIGS. 1A and 1B are schematics of the electrical circuit of the night light of the present invention.

FIG. 2 is an end elevation of the night light of the present invention.

FIG. 3 is a side elevation of the night light shown in FIG. 2.

FIG. 4 is a top view of the night light shown in FIGS. 2 and 3.

FIG. 5 is a perspective end view of the night light shown in FIGS. 2-4.

FIG. 6 is a side view showing the light pattern projected by the night light of the present invention on an adjacent wall.

FIG. 7 is an end elevation showing the light pattern projected by the night light of the present invention on an adjacent wall.

### DESCRIPTION OF THE PREFERRED EMBODIMENT

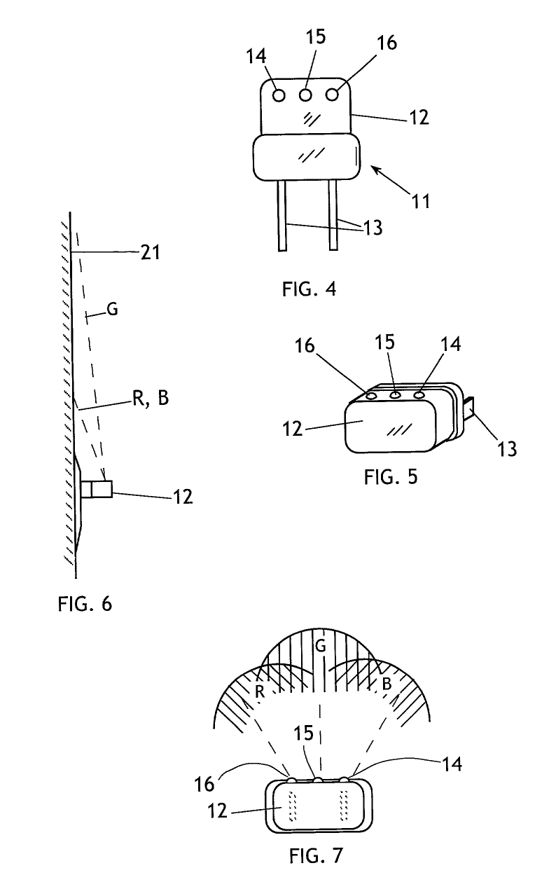

The present invention generally comprises a night light that consumes minimal power while at the same time providing an interesting color display. With reference to FIGS. 2-5, the night light 11 includes a housing 12 that is dimensioned to be similar to a typical electrical plug connector that is common in the prior art. A pair of spade lug electrical connectors 13 extend from the housing 12, and are dimensioned to be removably inserted in a typical electrical power receptacle known in the prior art. The connectors 13 provide power to a trio of LEDs 14, 15, and 16 that are mounted in the upper surface of the housing 12. The LEDs provide the night light illumination. Note that a greater number of LEDs may be provided to extend the illumination pattern and color blend scheme, as described below.

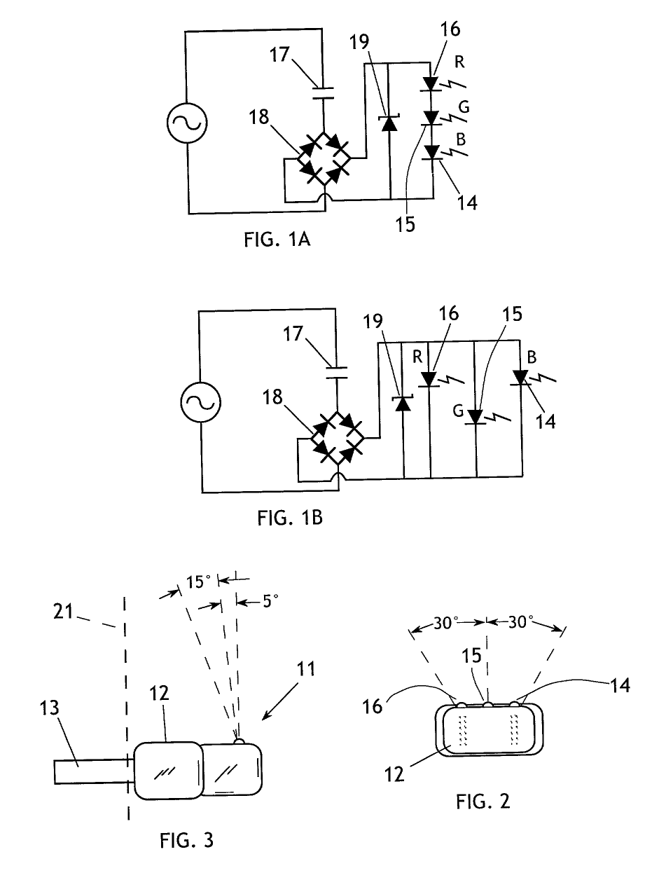

With reference to FIG. 1A, the circuit that drives the LEDs 14-16 includes a pick-off capacitor 17 connected to a full wave bridge rectifier 18. The output of the rectifier 18 is fed to the LEDs 14-16 in series, with a zener diode 19 connected in parallel to regulate the voltage across the LEDs to a safe level. Thus all the LEDs are illuminated in unison and operated with the same current level. As shown in FIG. 1B, the LEDs 14-16 may be connected in parallel to the zener diode 19, so that all LEDs are operated at the same voltage level.

A salient feature of the invention is the provision of LEDs of different colors, such as red, green, blue, amber, yellow, and any other colors that may be generated by LEDs. The LEDs 14-16 are spaced apart in their mountings in the housing 12, and are oriented and aimed to provide illumination fields that overlap. For example, as shown in FIGS. 6 and 7, the LEDs 14-16 may comprise the blue, green, and red LEDs, respectively The green LED in the center position may be aimed at approximately a 5° angle toward the wall 21 in which the power receptacle is located, whereas the red and blue LEDs are aimed at a total angle of approximately 20° toward the wall 21. As a result, the green illumination appears as an arc of illumination that is higher on the wall 21 than the red and blue arcs are somewhat lower. Moreover, the red and blue LEDs are aimed to diverge laterally approximately 30° from vertical, as shown in FIG. 2, whereas the green LED is aimed generally vertically. As a result of these angular relationships, the arcs of illumination on the wall 21 are partially overlapped to provide both pure spectral color and blends of varying degree of the three primary colors. The result is an approximation of a rainbow spectral display that is attractive to the eye and which also provides illumination sufficient to dissipate the total darkness of nighttime.

It is noted that LEDs of other color values may be used, the number of LEDs used may be increased, and the LEDs may be aimed to provide disparate combinations of colors. The aiming angles and overlap of the circles of illumination are not limited to the examples given herein, but may be selected for any desired color blend and display effect. In addition, at least some of the plurality of LEDs may have the same color value, if that combination is deemed to form a desirable consumer product.

It is known in the prior art that LEDs provide illumination efficiency that is unmatched by incandescent lamps or fluorescent lamps, and that LEDs have an operating life (MTBF) in the range of 10,000 to 100,000 hours. For example, a preferred embodiment may consume 1.25 watts, versus approximately 8 watts for a typical prior art nightlight, which may have an operating life of 1000-2000 hours. Thus the night light of this invention consumes minimal electrical power, and has extreme longevity.

The nightlight 11 is operated simply by plugging it into any convenient power receptacle, and switched off by unplugging from the receptacle. There is no switch required to operate the nightlight, and, indeed, no moving parts whatsoever. This feature enables the nightlight to combine extremely long-lived LED light sources with a power circuit that avoids any failure mode associated with moving parts, thus bolstering the longevity of the device. Notwithstanding, an ON-OFF switch may be provided, connected in series in the circuit delivering AC to the bridge rectifier 18, so that the device may be activated and deactivated without necessitating removal from the plug receptacle.

The foregoing description of the preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated.

1. A nightlight, including:
a housing;
connector means extending from said housing for connecting to an AC power source;
a plurality of LEDs supported by said housing and oriented to cast illumination in the vicinity of said housing; and,
circuit means connected to said connector means and to said plurality of LEDs for driving said LEDs to emit light.

2. The nightlight of claim 1, wherein said plurality of LEDs include at least two LEDs that emit light in different colors.

3. The nightlight of claim 2, wherein said at least two LEDs are oriented to cast fields of illumination that partially overlap to blend their respective colors.

4. The nightlight of claim 3, wherein said connector means includes spade connectors adapted to engage a power receptacle supported in a wall, and said at least two LEDs are oriented to cast said fields of illumination on a surface of the wall.

5. The nightlight of claim 4, wherein said circuit means includes rectifier means for receiving power from said AC power source and driving said LEDs with DC power.

6. The nightlight of claim 5, wherein said circuit means includes a pick-off capacitor connected between said AC power source and said rectifier means.

7. The nightlight of claim 1, wherein said plurality of LEDs each emit light in respective different colors.

8. The nightlight of claim 7, wherein said plurality of LEDs are oriented to cast fields of illumination that partially overlap to blend their respective colors.

9. The nightlight of claim 8, wherein said plurality of LEDs includes at least red, green, and blue LEDs.

10. The nightlight of claim 9, wherein said red and blue LEDs are directed to cast fields of illumination that are laterally spaced, and said green LED is direct to cast a field of illumination that overlaps said red and blue fields.

11. The nightlight of claim 10, wherein said connector means includes spade connectors adapted to engage a power receptacle supported in a wall, and said plurality of LEDs are oriented to cast said fields of illumination on a surface of the wall.

12. The nightlight of claim 1, wherein said connector means includes spade connectors adapted to engage a power receptacle supported in a wall, and said at plurality of LEDs are oriented to cast said fields of illumination on a surface of the wall.

13. The nightlight of claim 1, wherein said housing is configured to emulate the size and configuration of an electrical plug connector.

14. The nightlight of claim 1, wherein said circuit means includes rectifier means for receiving power from said AC power source and driving said LEDs with DC power.

15. The nightlight of claim 14, wherein said rectifier means includes a full-wave rectifier.

16. The nightlight of claim 15, wherein said plurality of LEDs are connected in series across the output of said full-wave rectifier.

17. The nightlight of claim 15, wherein said plurality of LEDs are connected in parallel across the output of said full-wave rectifier.

18. The nightlight of claim 15, further including voltage control means connected across the output of said full-wave rectifier.

19. The nightlight of claim 1, wherein said circuit means is devoid of any electrical switch.

20. The nightlight of claim 1, wherein said nightlight is devoid of any moving parts.

21. The nightlight of claim 1, wherein said circuit means includes an ON-OFF switch.

22. The nightlight of claim 1, wherein said plurality of LEDs include at least some LEDs having the same color value.
